(19) United States
(12) Patent Application Publication
(10) Pub. No.: US 2022/0188691 A1
(43) Pub. Date: Jun. 16, 2022

(54) Machine Learning Pipeline Generation

(71) Applicant: International Business Machines Corporation, Armonk, NY (US)

(72) Inventors: Michael Katz, Goldens Bridge, NY (US); Parikshit Ram, Atlanta, GA (US); Shirin Sohrabi Araghi, Briarcliff manor, NY (US); Octavian Udrea, Valhalla, NY (US)

(21) Appl. No.: 17/119,134

(22) Filed: Dec. 11, 2020

(51) Int. Cl. G06N 20/00

(52) U.S. Cl. CPC G06N 20/00

(57) ABSTRACT

The present disclosure includes a computer implemented method, system, and computer program product for automated generation of trained machine learning models and a machine learning model created using the method. The method may comprise receiving a space of possible automatically generated trained machine learning model pipelines, the space defined by a context-free grammar, generating, by a processor, a planning model from the context-free grammar, and automatically generating, by the processor, a plurality of candidate trained machine learning pipelines based upon the planning model.

### STATEMENT REGARDING PRIOR DISCLOSURES BY THE INVENTOR OR A JOINT INVENTOR

The following disclosure is submitted under 35 U.S.C. 102(b)(1)(A): Michael Katz, Parikshit Ram, Shirin Sohrabi, and Octavian Udrea, “Exploring Context-Free Languages via Planning: The Case for Automating Machine Learning,” 208 ICAPS20 403-411 (2020), which is herein incorporated by reference in its entirety.

### BACKGROUND

The present disclosure relates to artificial intelligence; and more specifically, to automated planning.

The development of the EDVAC system in 1948 is often cited as the beginning of the computer era. Since that time, computer systems have evolved into extremely complicated devices. Today's computer systems typically include a combination of sophisticated hardware and software components, application programs, operating systems, processors, buses, memory, input/output devices, and so on. As advances in semiconductor processing and computer architecture push performance higher and higher, even more advanced computer software has evolved to take advantage of the higher performance of those capabilities, resulting in computer systems today that are much more powerful than just a few years ago.

One application of these new capabilities is machine learning. While there is no doubt that the field of machine learning has achieved considerable successes in recent years, this success has relied on human experts spending countless hours on selecting appropriate features, workflows, algorithms with their hyper-parameters, etc., for those models.

### SUMMARY

According to embodiments of the present disclosure, a computer implemented method for automated generation of trained machine learning models and a machine learning model created using the method. The method may comprise receiving a space of possible automatically generated trained machine learning model pipelines, the space defined by a context-free grammar, generating, by a processor, a planning model from the context-free grammar, and automatically generating, by the processor, a plurality of candidate trained machine learning pipelines based upon the planning model.

According to embodiments of the present disclosure, a computer program product for automated generation of trained machine learning models. The computer program product may comprise a computer readable storage medium having program instructions embodied therewith. The program instructions may be executable by a processor to cause the processor to receive a space of possible automatically generated trained machine learning model pipelines, the space defined by a context-free grammar, generate, by a processor, a planning model from the context-free grammar; and automatically generate, by the processor, a plurality of candidate trained machine learning pipelines based upon the planning model.

According to embodiments of the present disclosure, a system for generating trained machine learning models. The system may comprise a processor configured to execute instructions that, when executed on the processor, cause the processor to receive a space of possible automatically generated trained machine learning model pipelines, the space defined by a context-free grammar, generate, by a processor, a planning model from the context-free grammar, and automatically generate, by the processor, a plurality of candidate trained machine learning pipelines based upon the planning model.

According to embodiments of the present disclosure, a computer implemented method for automated generation of trained machine learning models. The method may comprise receiving a space of possible automatically generated trained machine learning models, the space defined by a context-free grammar, and generating, by a processor, a planning model from the context-free grammar, translating the hierarchical task network planning model into a classical planning model; automatically generating, by the processor, a plurality of candidate trained machine learning pipelines based upon the classical planning model, training a plurality of candidate pipelines to generate a plurality of trained pipelines, generating feedback about the plurality of trained pipelines, presenting the feedback to a user. receiving a selection from a user for a preferred machine learning pipeline from the plurality of candidate trained machine learning pipelines, providing, by the processor, feedback from the selection of the preferred machine learning pipeline to an optimizer, and updating, by the optimizer, the planning model based upon the feedback. The planning model may comprise a strategy of action for training a machine learning model. The generating may comprise translating the context-free grammar to a hierarchical task network planning model. The hierarchical task network planning model may a solution to P^{G}=(Σ,V,O,M,s_{I},tn_{I}), where:

O={(n,∅,∅)|n∈Σ}

M={mᵣ=(α,∅,(Tᵣ, [symbol] ᵣ, τᵣ))|r=α→β∈R}, where β=e₁· . . . ·eₙ, Tᵣ={t₁, . . . , tₙ}, tᵢ [symbol] ᵣtⱼ if and only if i<j, and τᵣ(tᵢ)=eᵢ for 1≤i≤n,

s_{I}=∅, and

tn_{I}=({t_{I}},∅, τ_{I}), where τ_{I}(t_{I})=v₀.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates an embodiment of a data processing system (DPS), consistent with some embodiments.

FIG. 2 depicts a cloud computing environment, consistent with some embodiments.

FIG. 3 depicts abstraction model layers, consistent with some embodiments.

FIG. 4 is a grammar rules fragment, consistent with some embodiments.

FIGS. 5A, 5B, and 5C depict grammar rules, consistent with some embodiments.

FIG. 6A is a system diagram of a solution architecture, consistent with some embodiments.

FIG. 6B is a flow chart of the solution architecture in FIG. 6A in operation, consistent with some embodiments.

FIG. 7 depicts an example of a set of constraints chosen in addition to the context free grammar, consistent with some embodiments.

FIG. 8 is a pipeline visualization in LALE, consistent with some embodiments.

FIG. 9 depicts a pipeline training phase, consistent with some embodiments.

FIG. 10 depicts the pipeline accuracy used in the feedback mechanism, consistent with some embodiments.

FIG. 11 depicts a comparison between a first and second iteration of an example pipeline, consistent with some embodiments.

While the invention is amenable to various modifications and alternative forms, specifics thereof have been shown by way of example in the drawings and may be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to artificial intelligence; more particular aspects relate to automated planning. While the present disclosure is not necessarily limited to such applications, various aspects of the disclosure may be appreciated through a discussion of various examples using this context.

Machine learning generally refers to a field of Artificial Intelligence, in which algorithms typically build a model using a subset of data called “training data” to perform predictions or decisions without being specifically programmed to do so. Machine learning programs (or “pipelines”) are generally designed as sequences of algorithms chained together in a dataflow graph. Current approaches for exploring the space of pipelines suitable to solve problems within a given domain are generally restricted to problems modeled in a suitable input language and to searching a small predefined subspace of possible pipelines. No systematic approach to define and explore arbitrary large spaces of possible pipelines currently exists.

Automated planning generally refers to a sub-area of artificial intelligence (AI Planning) that aims at solving problems involving finding a strategy of action from a very large space of possible strategies. Accordingly, one aspect of this disclosure is a method and system to exploit the power of AI Planning to generate pipelines of complex Directed Acyclic Graph (DAG) shapes using a context free grammar (CFG) as input. In some embodiments, the CFG may be used to generate a restricted fragment of hierarchical task network (HTN) planning model, which may then be converted into a classical planning format. Classical planning tools may then be used to derive multiple plans from the classical planning format. The resulting plans may then be translated all the way back to strings in the CFG. Such translations to classical planning and back may allow for a goal-oriented exploration of strings in a grammar, a task of a particular interest for machine learning pipelines generation.

Some embodiments may start by creating a CFG to define how a pipeline can be composed. Some embodiments may then specify a problem of generating a plurality of possible pipelines from the CFG as an HTN planning problem, and then translate the HTN planning problem to classical planning format. These embodiments may be desirable because the classical planning format can be more flexible and may allow required features to be considered, e.g., costs, soft goals, etc.

Some embodiments may then solve the classical planning model with classical planners to generate multiple candidate plans; translate candidate plans to pipelines; train, optimize (non-categorical/all) hyper-parameters; and then feedback back everything into the classical planning model. Additionally, some embodiments may allow for user-guided exploration via a constraint the space of possible pipelines by specifying desired elements.

One feature and advantage of some embodiments is that the goal of the classical planning model may be extended to include user-specified constraints, focusing on specific elements that the user is interested to obtain in the pipeline. Some of these specified goals may include soft goals, which may be desirable if not all constraints can be satisfied simultaneously. These soft goals may extend the classical planning formalism in some embodiments, but can be then compiled away.

Another feature and advantage of some embodiments is the ability to modify the model through action costs modification techniques, e.g., preserving the solution space while modifying individual plans costs. These modifications may allow some embodiments to obtain different solutions when using cost-sensitive techniques.

Another feature and advantage of some embodiments is that they may be applied to help users to focus pipelines' exploration process. Experimental data shows that some embodiments are able to generate structurally complex pipelines in this way. Further, in some embodiments, the pipelines' accuracy may improve with each exploration.

Another feature and advantage of some embodiments is the ability to process more complex grammar than previous techniques. As an additional feature and advantage, some embodiments include a new classical planning domain.

### Preliminaries

While this disclosure is described with reference to automated machine learning, it is not limited to this application. For example, while some embodiments are described with reference to receiving a machine learning grammar as an input, the disclosure may work with any CFG and may be applied to other problems, such as natural language generation. The disclosure starts by describing the problem of exploring the space of strings for a CFG. Following the notation of Segovia-Aguas, Jiménez, and Jonsson, “Generating context-free grammars using classical planning,” in Proc. IJCAI 2017, 4391-4397 (2017), a Context-Free Grammar (CFG) may be defined as a tuple G=hV,v₀,Σ,Ri where V is the finite set of nonterminal symbols, v₀∈V is the start non-terminal symbol, Σ is the finite set of terminal symbols, and R={α→β|α∈V,β∈(V∪Σ)*} may be the finite set of production rules in the grammar. The semantics of CFG may be as follows: each v∈V may represent a sub-language of the language defined by the grammar and Σ may be the alphabet of the language defined by G and can contain the empty string, which may be denoted by ϵ∈Σ. e₀ may be denoted as a string that contains only the initial non-terminal symbol v₀. For a string e₁=u₁αu₂∈(V∪Σ)* and a rule r=α→β∈R, it may be said r that e₁ directly yields e₂=u₁βu₂, denoted by e₁−→e₂. It may also be said that e₁ yields eₙ (denoted by e₁→*eₙ) if, and only if, there exist strings e₁, . . . ,eₙ∈(V∪Σ)* and rules r₁, . . . ,rₙ₋₁∈R, rⁱ such that for all 1≤i<n we have eᵢ−→eᵢ₊₁. In such cases, r₁· . . . ·rₙ₋₁ may be an inducing sequence of rules for the pair of strings he₁,eₙi.

In the language of a CFG, L(G)={e∈Σ*:v₀→*e} may be the set of all strings that contain only terminal symbols and that may be yielded from the string e₀. For a set of symbols c⊆V∪Σ, in what follows referred to as a constraint, a constrained language L^{c}(G) may be defined as follows: for a string e, e∈L_{c}(G) if and only if: (i) e contains all the terminal symbols in c, and (ii) there exist an inducing sequence of rules r₁· . . . ·rₙ for the pair of strings (e₀,ei) such that c∩V⊆∪ᵢ₌₁ⁿ{v|rᵢ=v→α}. In other words, the constrained language may consist of strings that can be yielded from the string e₀through all constrained symbols.

Accordingly, given a CFG G and a constraint c, a constrained string existence may be a problem of deciding whether there exists a string s∈L^{c}(G) in some embodiments. Additionally, given a CFG G and a constraint c, a constrained string generation may be a problem of generating a string s∈L^{c}(G).

For HTN Planning, this disclosure follows the notation of Alford et al. “Bound to plan: Exploiting classical heuristics via automatic translations of tail-recursive HTN problems,” in Proc. ICAPS 2016, 20-28 (2016) (“Alford et al. (2016)”) and Bercher, Alford, and Holler “A survey on hierarchical planning—one abstract idea, many concrete realizations,” in Proc. IJCAI 2019, 6267-6275 (2019). In this notation, a HTN problem may be a tuple P=(Xₚ,Xₙ,O,M,s_{I},tn_{I}), where:
Xₚ and Xₙ are a finite set of primitive and non-primitive task names respectively,
O is a set of HTN operators, where each o∈O is a triple (n,χ,e), with n∈Xₚ being a primitive task name, χ the precondition, and e the effect of the planning operator,
M is a set of HTN methods, where each m∈M is a triple (c,χ,tn), with c∈Xₙ, being a non-primitive task name, χ being the precondition of m, and tn being a task network,
s_{I} is the initial state and tn₁ is the initial task network.
   A task network may be defined as a tuple tn=(T, [symbol] ,τ), where T is a finite set of task instance symbols, [symbol] is a partial order over T, and τ:T→(Xₚ∪Xₙ) is a mapping from the task instance symbols to task names.

The full semantics of HTN Planning is described in Alford et al. (2016). A task network tnₛ may be a solution to an HTN problem P if and only if tnₛ can be obtained from the initial task network tn_{I} by a sequence of method or operator applications (progression), does not contain non-primitive tasks, and is executable (e.g., it contains a linearization of its primitive tasks that is executable from the initial state s_{I}).

### Data Processing System

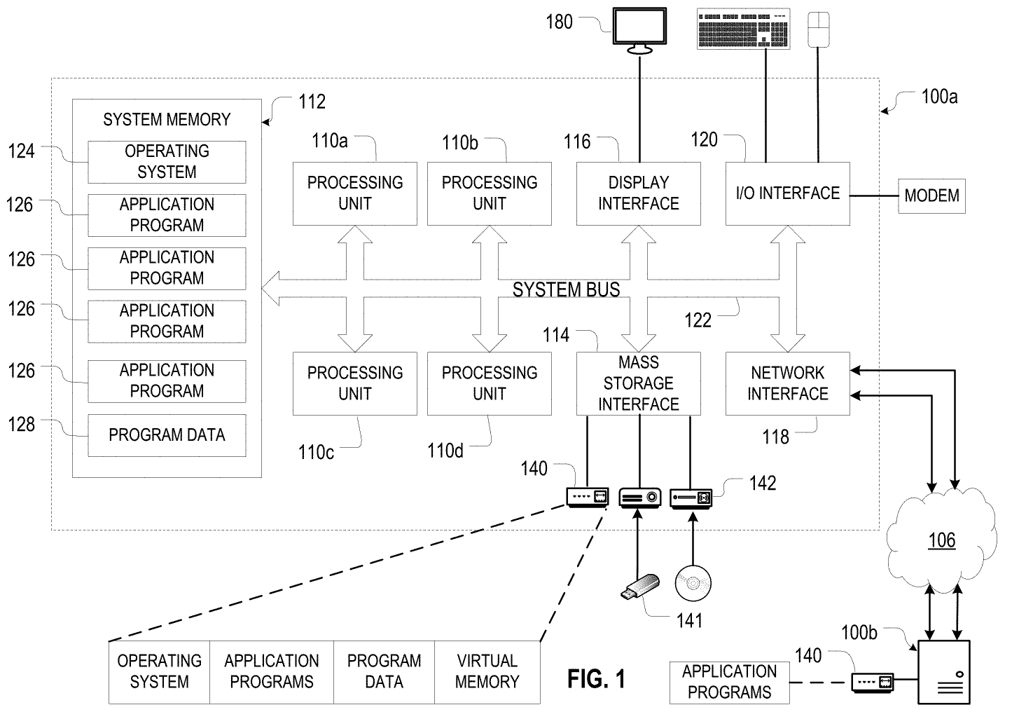

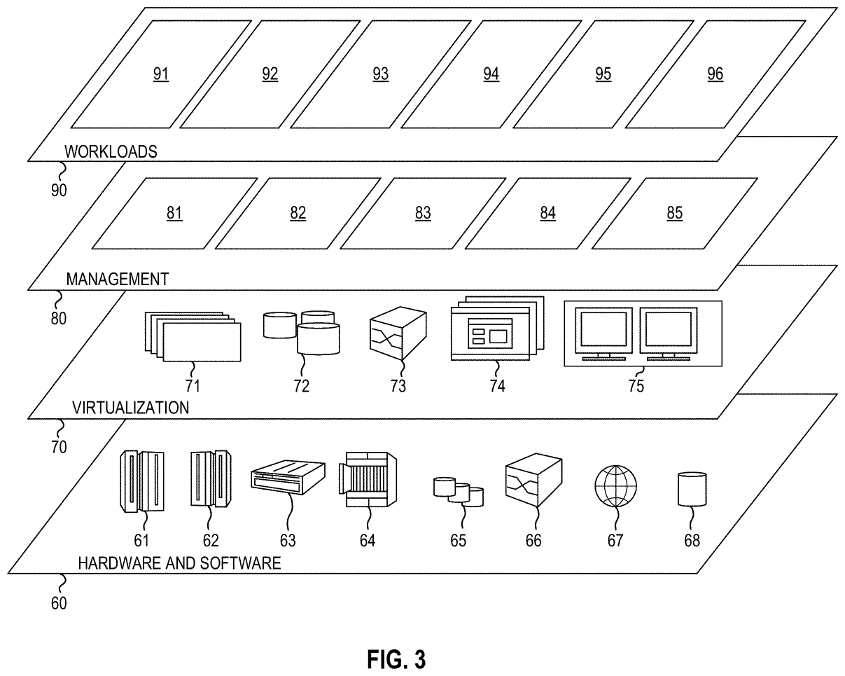

FIG. 1 illustrates an embodiment of a data processing system (DPS) 300, consistent with some embodiments. The DPS 300 in this embodiment may be implemented as a personal computer; server computer; portable computer, such as a laptop or notebook computer, PDA (Personal Digital Assistant), tablet computer, or smart phone; processors embedded into a larger devices, such as an automobile, airplane, teleconferencing system, appliance; smart devices; or any other appropriate type of electronic device. Moreover, components other than or in addition to those shown in FIG. 3 may be present, and that the number, type, and configuration of such components may vary. Moreover, FIG. 3 only depicts the representative major components of the DPS 300, and individual components may have greater complexity than represented in FIG. 3.

The data processing system 300 in FIG. 3 comprises a plurality of central processing units 310a-310d (herein generically referred to as a processor 310 or a CPU 310) connected to a memory 312, a mass storage interface 314, a terminal/display interface 316, a network interface 318, and an input/output (“I/O”) interface 320 by a system bus 322. The mass storage interface 314 in this embodiment connect the system bus 322 to one or more mass storage devices, such as a direct access storage device 340, universal serial bus (“USB”) storage device 341, or a readable/writable optical disk drive 342. The network interfaces 318 allow the DPS 300 to communicate with other DPS 300 over the communications medium 306. The memory 312 also contains an operating system 324, a plurality of application programs 326, and program data 328.

The data processing system 300 embodiment in FIG. 3 is a general-purpose computing device. Accordingly, the processors 310 may be any device capable of executing program instructions stored in the memory 312 and may themselves be constructed from one or more microprocessors and/or integrated circuits. In this embodiment, the DPS 300 contains multiple processors and/or processing cores, as is typical of larger, more capable computer systems; however, in other embodiments the computing systems 300 may comprise a single processor system and/or a single processor designed to emulate a multiprocessor system. Further, the processors 310 may be implemented using a number of heterogeneous data processing systems 300 in which a main processor is present with secondary processors on a single chip. As another illustrative example, the processor 310 may be a symmetric multi-processor system containing multiple processors of the same type.

When the data processing system 300 starts up, the associated processor(s) 310 initially execute the program instructions that make up the operating system 324, which manages the physical and logical resources of the DPS 300. These resources include the memory 312, the mass storage interface 314, the terminal/display interface 316, the network interface 318, and the system bus 322. As with the processor(s) 310, some DPS 300 embodiments may utilize multiple system interfaces 314, 316, 318, 320, and busses 322, which in turn, may each include their own separate, fully programmed microprocessors.

Instructions for the operating system, applications and/or programs (generically referred to as “program code,” “computer usable program code,” or “computer readable program code”) may be initially located in the mass storage devices 340, 341, 342, which are in communication with the processors 310 through the system bus 322. The program code in the different embodiments may be embodied on different physical or tangible computer readable media, such as the system memory 312 or the mass storage devices 340, 341, 342. In the illustrative example in FIG. 3, the instructions are stored in a functional form of persistent storage on the direct access storage device 340. These instructions are then loaded into the memory 312 for execution by the processor 310. However, the program code may also be located in a functional form on the computer readable media 342 that is selectively removable and may be loaded onto or transferred to the DPS 300 for execution by the processor 310.

The system bus 322 may be any device that facilitates communication between and among the processors 310; the memory 312; and the interfaces 314, 316, 318, 320. Moreover, although the system bus 322 in this embodiment is a relatively simple, single bus structure that provides a direct communication path among the system bus 322, other bus structures are consistent with the present disclosure, including without limitation, point-to-point links in hierarchical, star or web configurations, multiple hierarchical buses, parallel and redundant paths, etc.

The memory 312 and the mass storage devices 340, 341, 342 work cooperatively to store the operating system 324, the application programs 326, and the program data 328. In this embodiment, the memory 312 is a random-access semiconductor device capable of storing data and programs. Although FIG. 3 conceptually depicts that device as a single monolithic entity, the memory 312 in some embodiments may be a more complex arrangement, such as a hierarchy of caches and other memory devices. For example, the memory 312 may exist in multiple levels of caches, and these caches may be further divided by function, so that one cache holds instructions while another holds non-instruction data, which is used by the processor or processors. Memory 312 may be further distributed and associated with different processors 310 or sets of processors 310, as is known in any of various so-called non-uniform memory access (NUMA) computer architectures. Moreover, some embodiments may utilize virtual addressing mechanisms that allow the DPS 300 to behave as if it has access to a large, single storage entity instead of access to multiple, smaller storage entities such as the memory 312 and the mass storage device 340, 341, 342.

Although the operating system 324, the application programs 326, and the program data 328 are illustrated as being contained within the memory 312, some or all of them may be physically located on different computer systems and may be accessed remotely, e.g., via the communications medium 306, in some embodiments. Thus, while the operating system 324, the application programs 326, and the program data 328 are illustrated as being contained within the memory 312, these elements are not necessarily all completely contained in the same physical device at the same time and may even reside in the virtual memory of other DPS 300.

The system interfaces 314, 316, 318, 320 support communication with a variety of storage and I/O devices. The mass storage interface 314 supports the attachment of one or more mass storage devices 340, 341, 342, which are typically rotating magnetic disk drive storage devices, a solid-state storage device (SSD) that uses integrated circuit assemblies as memory to store data persistently, typically using flash memory, or a combination of the two. However, the mass storage devices 340, 341, 342 may also comprise other devices, including arrays of disk drives configured to appear as a single large storage device to a host (commonly called RAID arrays) and/or archival storage media, such as hard disk drives, tape (e.g., mini-DV), writeable compact disks (e.g., CD-R and CD-RW), digital versatile disks (e.g., DVD, DVD-R, DVD+R, DVD+RW, DVD-RAM), holography storage systems, blue laser disks, IBM Millipede devices, and the like.

The terminal/display interface 316 is used to directly connect one or more display units, such as monitor 380, to the data processing system 300. These display units 380 may be non-intelligent (i.e., dumb) terminals, such as an LED monitor, or may themselves be fully programmable workstations used to allow IT administrators and customers to communicate with the DPS 300. Note, however, that while the display interface 316 is provided to support communication with one or more display units 380, the computer systems 300 does not necessarily require a display unit 380 because all needed interaction with customers and other processes may occur via network interface 318.

The communications medium 306 may be any suitable network or combination of networks and may support any appropriate protocol suitable for communication of data and/or code to/from multiple DPS 300. Accordingly, the network interfaces 318 can be any device that facilitates such communication, regardless of whether the network connection is made using present day analog and/or digital techniques or via some networking mechanism of the future. Suitable communication media 306 include, but are not limited to, networks implemented using one or more of the “InfiniBand” or IEEE (Institute of Electrical and Electronics Engineers) 802.3x “Ethernet” specifications; cellular transmission networks; wireless networks implemented one of the IEEE 802.11x, IEEE 802.16, General Packet Radio Service (“GPRS”), FRS (Family Radio Service), or Bluetooth specifications; Ultra-Wide Band (“UWB”) technology, such as that described in FCC 02-48; or the like. Those skilled in the art will appreciate that many different network and transport protocols can be used to implement the communications medium 306. The Transmission Control Protocol/Internet Protocol (“TCP/IP”) suite contains suitable network and transport protocols.

### Cloud Computing

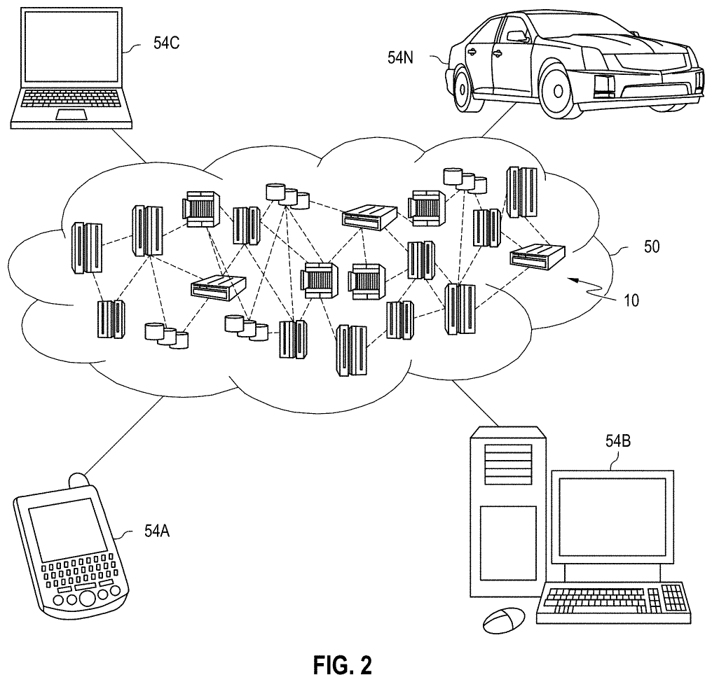

FIG. 2 illustrates a cloud environment containing one or more DPS 100, consistent with some embodiments. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active customer accounts). Resource usage can be monitored, controlled, and reported, providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited customer-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

Referring now to FIG. 3, a set of functional abstraction layers provided by cloud computing environment 50 (FIG. 2) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. Customer portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and an automated planning service 96.

### Machine Learning Pipelines & Grammar

Next, the disclosure considers a CFG to define a search space that may allow it to not only search over ML operators, but also over complex pipeline shapes/structures. Some embodiments may define pipelines with complex structures utilizing the following “combinators” in the LALE python library, as described in more detail in Hirzel et al. “Type-driver automated learning with late” in arXiv:1906.03957 [cs.PL, cs.LG, cs.SE] (2019) (LALE version 0.4.9 is currently available in source form under the terms of the Apache 2.0 license at https://pypi.org/project/lale/):
The >> combinator may perform a ‘pipe’ operation, where α>>β is a pipeline where the data goes into the α operator and the output of α is piped into the β operator.
The & combinator performs parallel independent executions, where α & β may be a (partial) pipeline with the operators α and β applied to the data independently in parallel. The output of this (partial) pipeline could be piped (>>) into the LALE concat operator to concatenate (or horizontally stack) the features—the pipeline would be defined as (α & β)>>Concat.
   In the above examples, the operators α, β may be ML operators as well as themselves be (partial) pipelines.

While this disclosure is not limited to embodiments using LALE, those that use LALE may be desirable because they can make the definition of complex pipelines relatively succinct, allowing some embodiments to consider a concise CFG with strings in its language corresponding to executable LALE code.

### AutoML Grammar

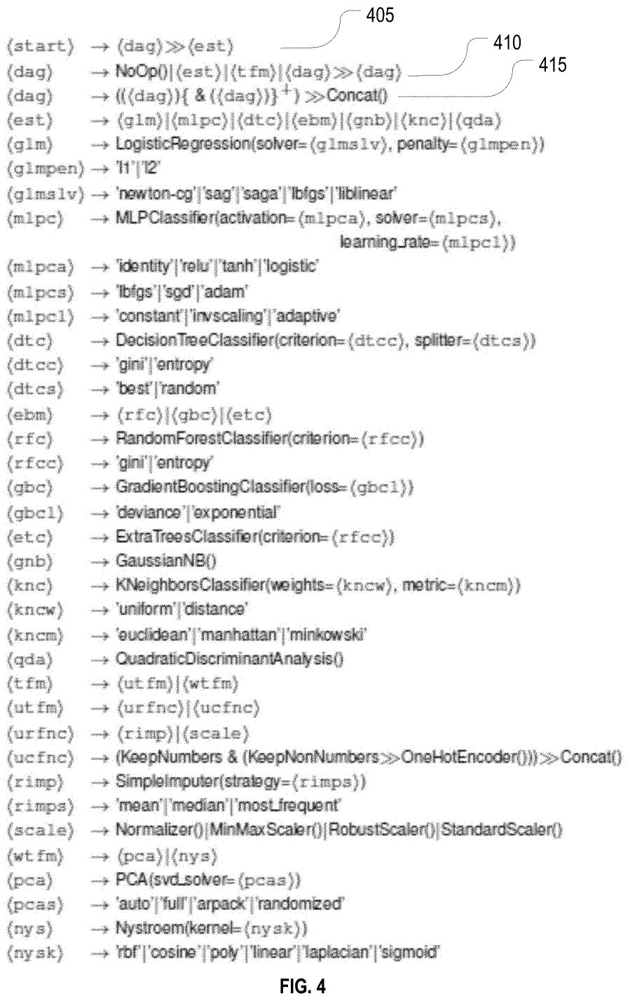

Some embodiments equipped with LALE may define a CFG for pipelines. While this disclosure is not restricted to any particular grammar, FIG. 4 provides an example CFG that encodes the search space for both the shape of the data-flow graph of the pipeline and the ML operators used in the pipelines, consistent with some embodiments.

In FIG. 4, a pipeline valid under this CFG may be an executable LALE pipeline i.e., the grammar directly generates executable code. To save space, the notation α→β|γ may be used to denote two rules, α→β and α→γ. Further, the symbol {α}⁺ is used to denote at least one appearance of the (terminal or non-terminal) symbol α, which may be encoded by an additional rule. The non-terminal symbols may be denoted by hαi and the terminal symbols may be the other strings. For example, the right hand side of the rule:
[symbol] rfc [symbol] →RandomForestClassifier(criterion= [symbol] rfcc [symbol] )
   may have one non-terminal symbol [symbol] rfcc [symbol] and two terminal symbols:
“RandomForestClassifier(criterion=”and
“)”.

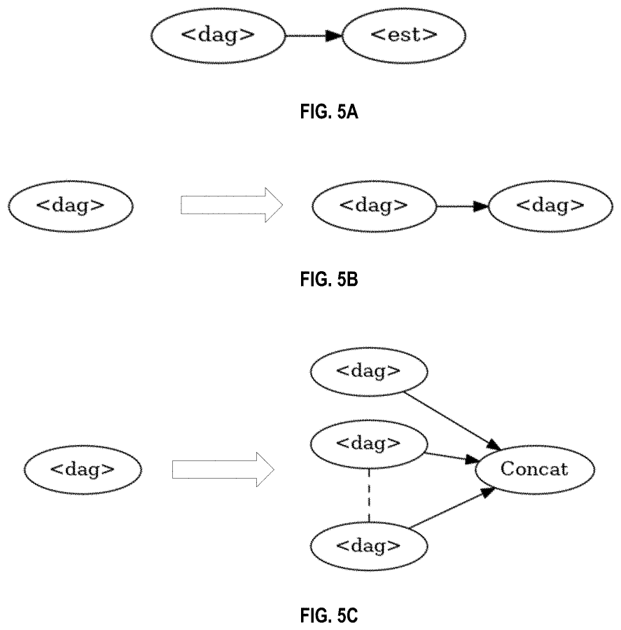

The first three production rules 405, 410, 415 in FIG. 4 may encode the shape of the pipelines. The first rule 405 for the non-terminal [symbol] start [symbol] symbol indicates that the pipeline contains a data flow graph (denoted by the non-terminal [symbol] dag [symbol] ) piped into a ML modeling operation (or estimator [symbol] est [symbol] ), described in more detail with reference to FIG. 5a below. The production rules for [symbol] dag [symbol] 410, 415 may allow it to be:
A NoOp, implying the data is passed as-is;
a [symbol] est [symbol] symbol, which allows us to encode the practice of using predictions from one ML modeling step as features for downstream data processing and modeling;
a [symbol] tfm [symbol] symbol corresponding to ML data preprocessing and transformation operators;
an extension of the pipeline via the recursive [symbol] dag [symbol] v>> [symbol] dag [symbol] symbols containing the LALE pipe combinator, allowing the pipeline to be of arbitrary length (FIG. 5B); and
another form of extending the pipeline data-flowgraph via the recursive (( [symbol] dag [symbol] ){&( [symbol] dag [symbol] )}⁺)>>Concat( ) containing the LALE “&” combinator, allowing the pipeline data-flow graph to contain parallel data processing paths followed by a concatenation of features (FIG. 5C).

The remaining production rules in FIG. 4 may provide the different options for the non-terminal [symbol] est [symbol] corresponding to the ML modeling operators and the non-terminal [symbol] hfm [symbol] corresponding to the ML transformation operators. The production rules may also demonstrate how embodiments can handle categorical (non-numeric) hyper-parameters within the CFG. For example:

[symbol]

est [symbol] → [symbol] mlpc

[symbol]

and

[symbol]

mlpc [symbol] →MLPClassifier(activation= [symbol] mlpca [symbol] , solver= [symbol] mlpcs [symbol] , learning_rate= [symbol] mlpcl [symbol] )

may specify the neural network modeling operator MLPClassifier from scikit-learn (Pedregosa et al. “Scikit-learn: Machine learning in Python,” JMLR 12:2825-2830 (2011)), along with its categorical hyper-parameters for the neuron activation function [symbol] mlpca [symbol] , optimization solver [symbol] mlpcs [symbol] and the learning rate schedule [symbol] mlpcl [symbol] for the optimization solver, defined appropriately in the subsequent production rules.

### Constrained AutoML

This section details one approach for automatically generating high performing Machine Learning pipelines given a context-free grammar for ML pipelines, consistent with some embodiments. While automation may provide ease to the users, there may be cases where a user wishes to provide certain constraints on outcome pipelines. Because the users specify the input as a grammar, these constraints may also be specified in terms of the grammar.

In one example, a user can select specific non-terminal or terminal symbols in the grammar, e.g., they can select the [symbol] dtc [symbol] and [symbol] ebm [symbol] non-terminals to constrain the automated pipeline configuration to a decision tree based ML model for the modeling step or just select [symbol] ebm [symbol] if they prefer only tree-based ML ensembles. As will be discussed in the next section, the CFG may make it simpler to specify multiple such constraints, allowing the user to potentially incorporate any domain knowledge or requirements. Furthermore, the CFG itself may be modified in a manner that further facilitates the constraint specification without changing the language defined by the grammar. For example, some embodiments may modify the following production rule:

[symbol]

est [symbol] → [symbol] glm [symbol] | [symbol] mlpc [symbol] | [symbol] dtc [symbol] | [symbol] ebm [symbol] | [symbol] gnb [symbol] | [symbol] knc [symbol] | [symbol] qda

[symbol]

into a different organization as follows:

[symbol]

est [symbol] → [symbol] glm [symbol] | [symbol] mlpc [symbol] | [symbol] tree [symbol] | [symbol] others

[symbol]

[symbol]

tree [symbol] → [symbol] dtc [symbol] | [symbol] ebm

[symbol]

[symbol]

others [symbol] → [symbol] gnb [symbol] | [symbol] knc [symbol] | [symbol] qda

[symbol]

This modified grammar may make it easier for the user to specify a constraint, for example only choosing tree-based methods by only selecting a single non-terminal (tree).

### Solution Scheme

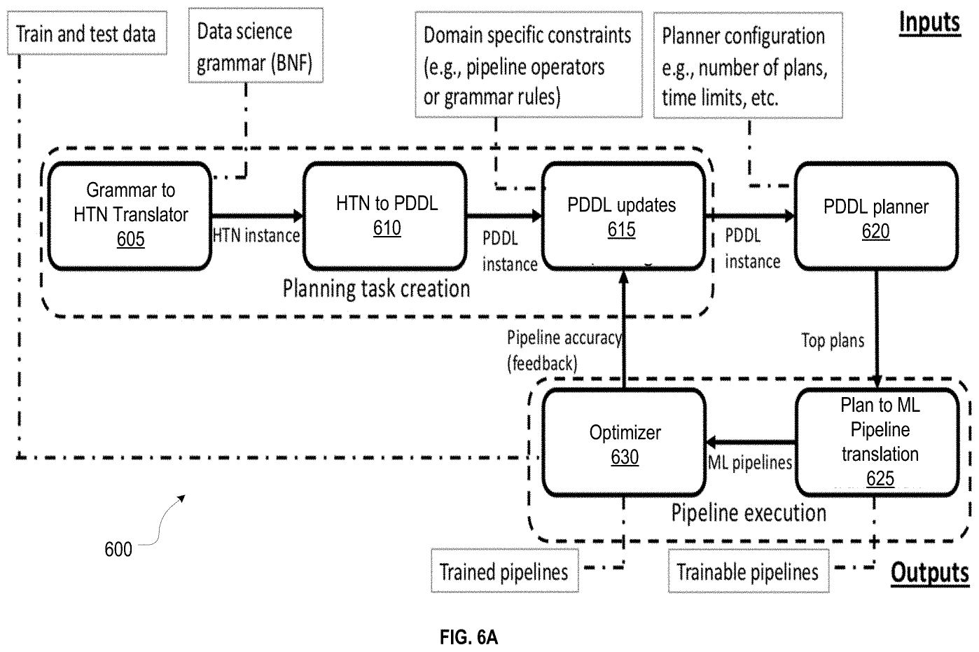

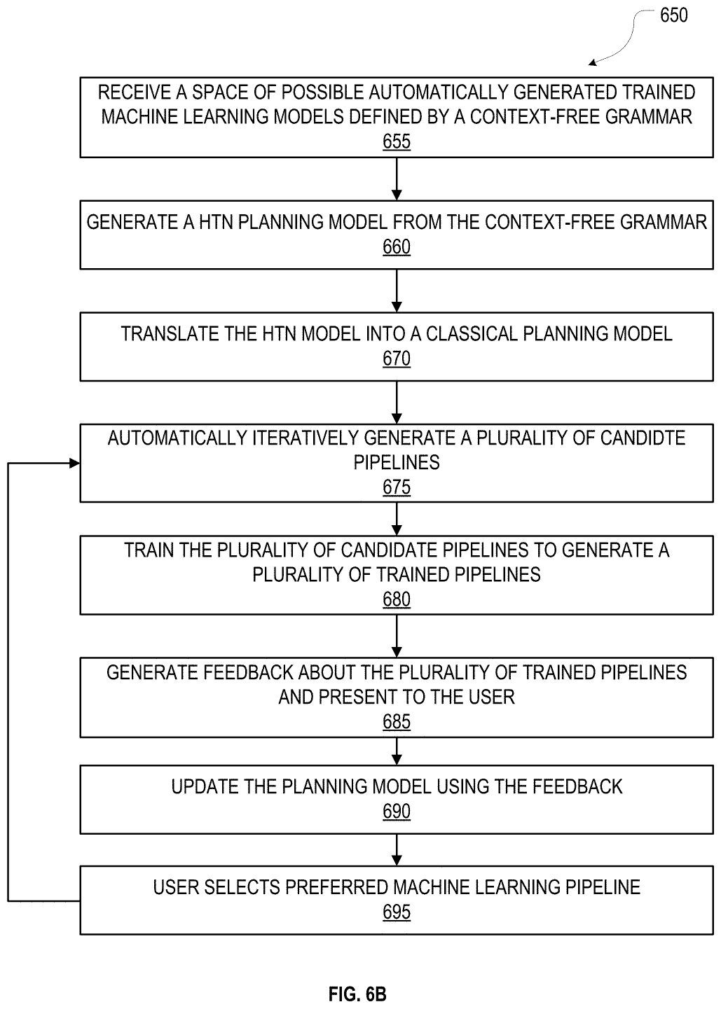

FIG. 6A is a system diagram of a solution architecture 600, consistent with some embodiments. The embodiment in FIG. 4 may comprises a Grammar→HTN translator 605, a HTN→Planning Domain Definition Language (PDDL) translator 610, a PDDL updates tool 615, a PDDL planner 620, a Plan→ML pipeline (LALE) translation tool 625, and an optimizer 630.

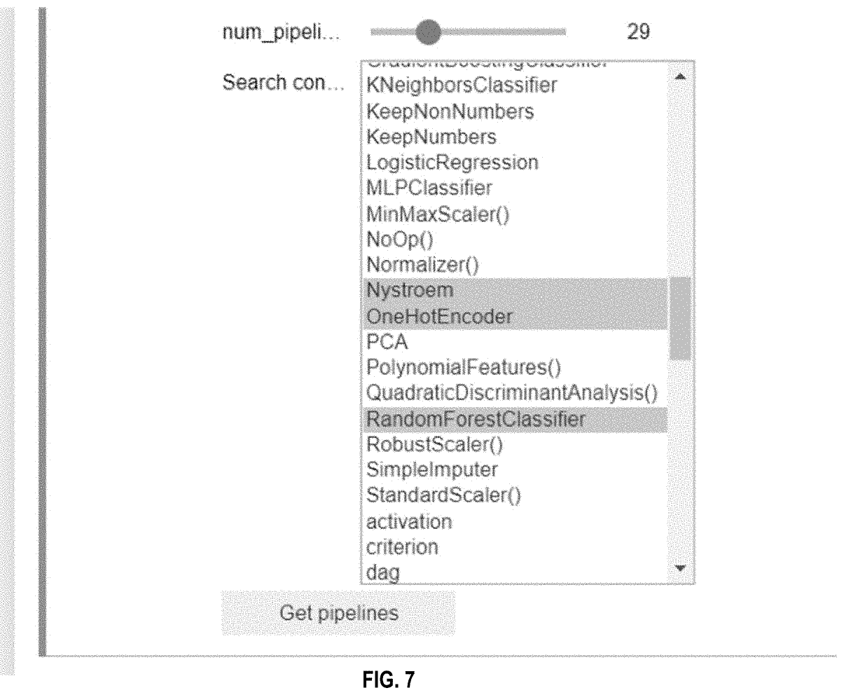

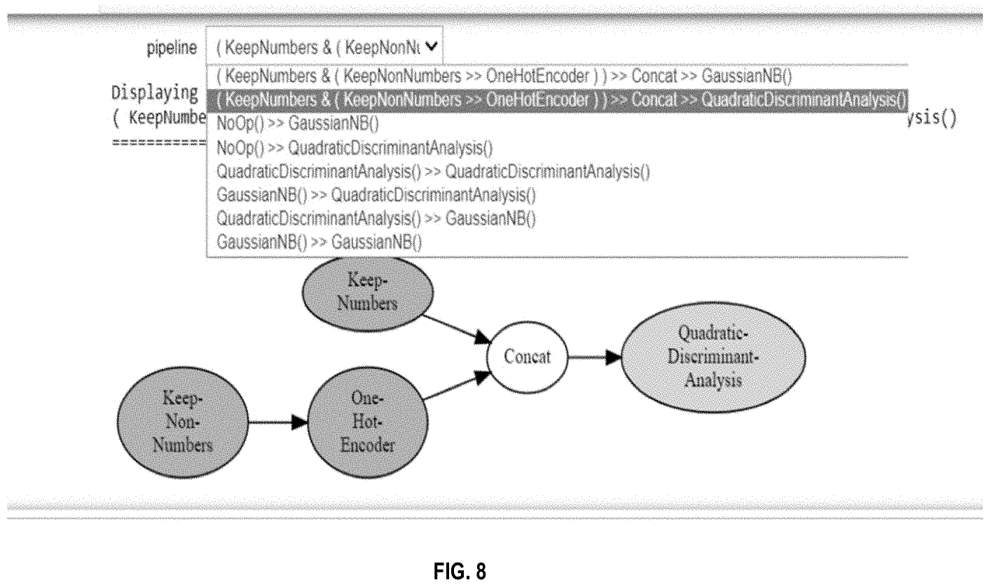

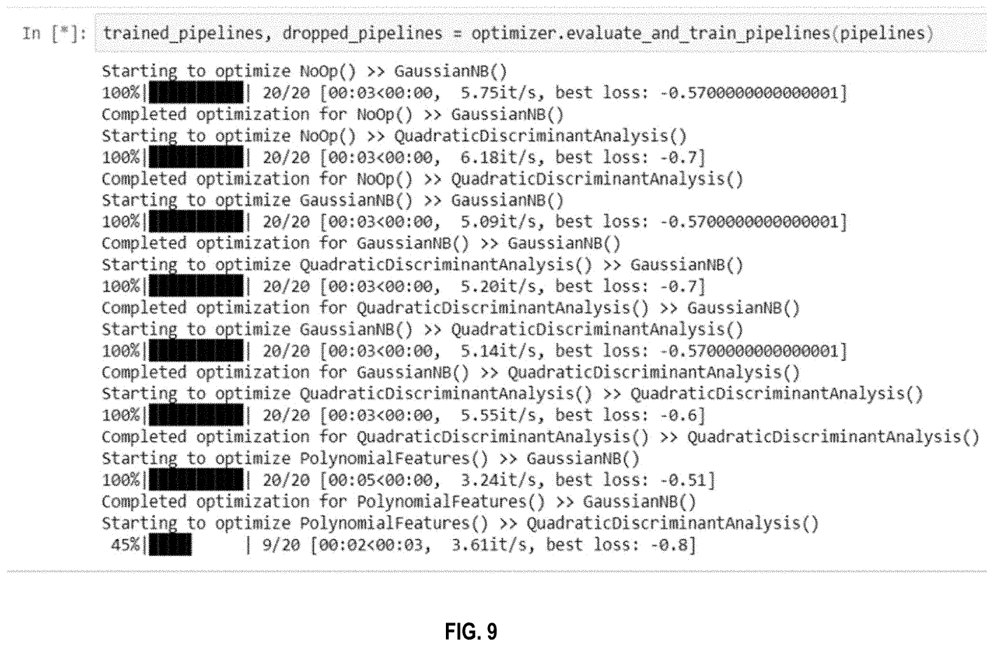

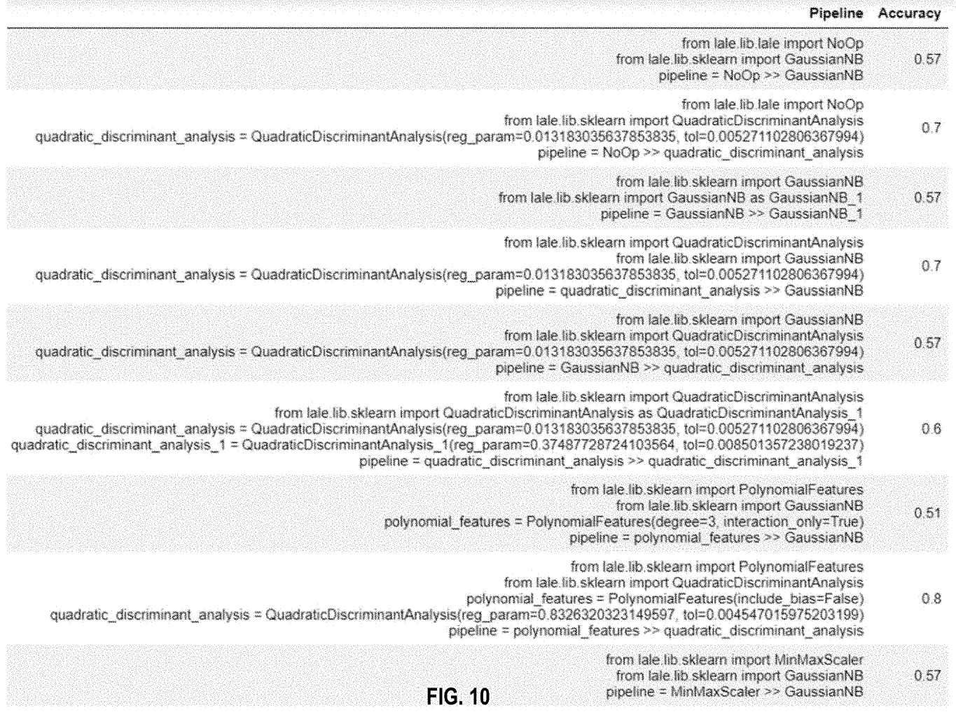

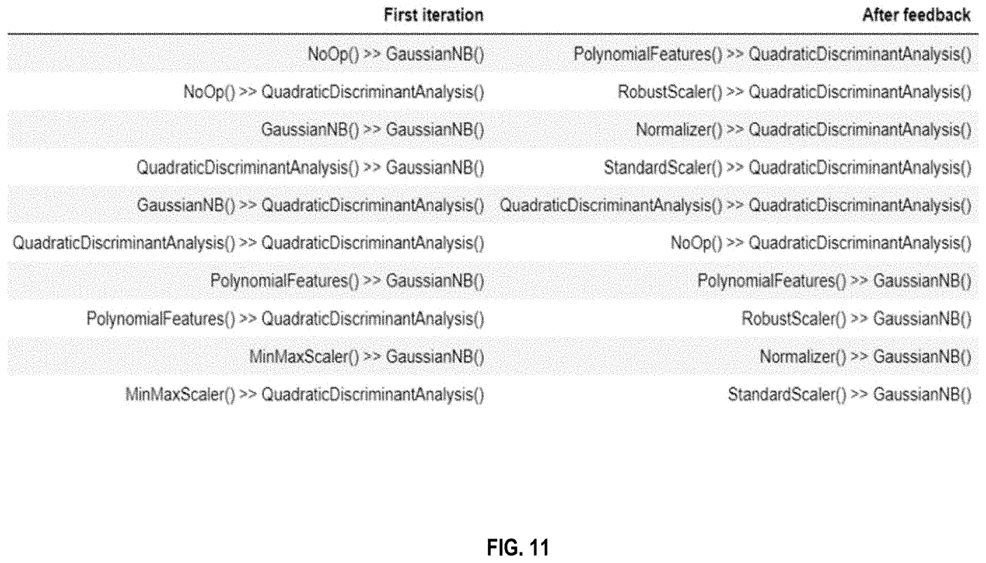

In some embodiments:
Grammar→HTN translator 605. The (unconstrained) context-free grammar (e.g., the ‘Data Science BNF’ input in FIG. 6) may be translated into an HTN Planning model (e.g., Alford et al. 2016) as detailed below.
HTN→PDDL 410. The HTN model may be translated into classical planning (e.g., using Alford, Kuter, and Nau 2009). Some embodiments may use a tool for STRIPS-compatible translation for totally-ordered problems. The algorithm may allow for specifying a parameter that roughly corresponds to the non-tail recursion depth of the HTN. In this example, that parameter is set to twenty.
PDDL update tool 615: action costs, soft/hard goals. The classical planning model may be updated to incorporate the constraints as hard goals. This may be done by extending the goal of the translated classical planning task with atoms that correspond to the constraints (c.f. FIG. 7). Further, some embodiments may allow tweaking the planning model by modifying the costs of individual actions. This may allow quality aware planners to produce solutions different from previously found ones.
PDDL planner tool 620. Some embodiments may exploit planners that produce multiple solutions, such as Katz et al. 2018; Katz, Sohrabi, and Udrea 2020; and Katz and Sohrabi 2020 to derive multiple plans, translating these plans to strings in the constrained CFG. By using quality or diversity focused planners, some embodiments may control the exploration through the space of strings in the constrained CFG. Further, these constraints can be easily relaxed by turning the corresponding hard goals into soft goals. Such soft goals may be compiled away, producing again a classical planning model, such as those described in Keyder and Geffner 2009. Additionally, some embodiments may use the top-k planner in Katz et al. 2018.
Plan→ML pipeline (LALE) translation tool 625. A set of plans may be translated into a set of Machine Learning pipelines, such as the LALE pipelines described in Hirzel et al. 2019. An example pipeline visualization in LALE is shown in FIG. 8.
Optimizer 630. The pipelines may be trained (with unspecified hyper-parameters configured with an off-the-shelf hyper-parameter optimizer, such as HyperOpt or SMAC) on the training data and their performance is tested on held-out data. One example of such a training is shown in FIG. 9. The accuracy of trained pipelines may be translated into a feedback on a quality of the pipeline, expressed in action costs (see FIGS. 10-11). The feedback may then be used as an input to operation III, to update the classical planning model. This computation is described in more detail below.

In some embodiments, the translation of unconstrained CFG to HTN planning models, as well as the action cost modification from the feedback, may be performed as follows. Given a CFG G=(V,v₀,Σ,R) as defined earlier, some embodiments may define an induced HTN Planning problem P_{G}=(Σ,V,O,M,s_{I},tn_{I}) where:

O={(n,∅,∅)|n∈Σ}

M={mᵣ=(α,∅,(Tᵣ, [symbol] ᵣ,τᵣ))|r=α→β∈R}, where β=e₁· . . . ·eₙ, Tᵣ={t₁, . . . ,tₙ}; tᵢ [symbol] ᵣtⱼ if and only if i<j, and τᵣ(tᵢ)=eᵢ for 1≤i≤n,

s_{I}=∅, and

tn_{I}=({t_{I}},∅,τ_{I}, where τ_{I}(t_{I})=v₀.

Some embodiments may introduce a predicate for each operator, describing whether the operator was applied. Other embodiments may add such predicates to the classical planning model. In this way, some embodiments may define an operator with empty precondition and effects for each terminal node in the grammar and a method for each production rule. Multiple production rules with the same left-hand side symbols in some embodiments may result in multiple methods for the same task. The initial task network may comprise one task that represents the initial non-terminal symbol in the grammar.

For a CFG G in some embodiments, there may be a bijective mapping between its language L(G) and the set of solutions to its induced HTN Planning problem P^{G}. More specifically, let tnₛ=(T, [symbol] ,τ) be a solution to the HTN problem P^{G}. Then T={t₁, . . . ,tₙ} may consist of primitive tasks only. Further, [symbol] may be a total order over T, without loss of generality, t₁· . . . ·tₙ, because each method's task network may correspond to a total order over its tasks. Let e=τ(t₁)· . . . ·τ(tₙ) be the corresponding sequence of terminal symbols, ρ be the sequence of method and operator applications that produced tnₛ, and m₁, . . . ,mₖ be the sub-sequence of ρ of methods. Then, applying the corresponding sequence of rules r₁, . . . ,rₖ to the initial string e₀ would result in e and therefore e∈L(G). For the other direction, let e=e₁· . . . ·eₙ∈L(G). Among the possible sequences of rules that may yield e from e₀, let r₁, . . . ,rₖ be one such that at each step i the rule rᵢ is applied to the left-most non-terminal symbol. Then, a sequence of method and operator applications that produces a solution to the HTN problem P^{G may} be obtained by merging the sequences m₁, . . . , mₖ of methods and e₁, . . . , eₙ of operators.

In some embodiments, action costs may be updated automatically after each optimization round as follows. First, all feedback from the optimizer may be recorded from the beginning of the process. The feedback may take the form of scores in [0,1] per pipeline, based on the optimized metric, be it accuracy, area under the curve, or fairness, with higher scores being better. Given all such scores for pipelines, each action may be assigned an integer cost between 1 and highest possible action cost (e.g., 100 in this example), inversely proportional to the average score of the pipelines in which it appears. Actions that have not yet appeared in any pipeline receive a default score (e.g., 30 in this example).

FIG. 6B is a flow chart 650 of the solution architecture 600 in operation, consistent with some embodiments. At operation 655, a space of possible automatically generated trained machine learning models may be received. This space may be defined by a context-free grammar. At operation 660, a planning model from the context-free grammar may be generated by a processor of a DPS, such as DPS 100. The planning model may comprise a strategy of action for training a machine learning model, and generating the planning model may comprise translating the context-free grammar to a hierarchical task network planning model.

At operation 670, the hierarchical task network planning model may be translated into a classical planning model. A plurality of candidate pipelines may then be automatically iteratively generated at operation 675 using the classical planning model. At operation 680, the plurality of candidate pipelines may be trained to generate a plurality of trained pipelines. Feedback about the plurality of trained pipelines may be generated and presented to the user at operation 685. This feedback may be automatically generated from the accuracy scores depicted in FIG. 10 and used to update the planning model at operation 690

In some embodiments, a user may select a preferred machine learning pipeline from the one or more automatically generated candidates at operation 695. In response, the system may provide, by the processor of the DPS 100, feedback from the selection of the preferred machine learning pipeline to an optimizer and/or the user may continue exploration at operation 675. This user-guided exploration process will be described in more detail below.

In some embodiments, the system may provide, by the processor of the DPS 100, the feedback generated at operation 685 to an optimizer, which may then update the planning model accordingly. The exploration of machine learning pipelines continues from operation 675, where a new plurality of candidate pipelines is generated, this time based on the planning model updated from feedback. The lists at each iteration may, and most times are different, as shown in the two iterations shown side by side in FIG. 11. After operation 685, the user may choose at any point to stop the exploration loop in operation 690, by selecting one or more desired machine learning pipelines.

### User Guided Exploration

In some embodiments, the system 400 in FIG. 4 may be implemented as a python notebook in a docker container. In these embodiments, the user may have an option to select a data science grammar from a list of possible grammars (see, e.g., the grammar in FIG. 4). The HTN domain may then be created from the data science grammar followed by translating the HTN model to classical planning, such as described in Alford et al. 2016. The user may then be allowed to select a set of constraints as well as the number of pipelines they like to generate as shown in FIG. 7. This operation is optional, but selecting constraints may allow the user to obtain pipelines that better match what they are interested in. Recall that the constraints may be treated as soft goals; a subset of them will be met if it is not possible to obtain solutions that would meet the selected constraints.

Next, the user may have the ability to explore the generated pipelines further by visualizing them. The set of generated pipelines will be shown in a drop-down menu and the user has the ability to select a desired pipeline and visualize them. An example is shown in FIG. 8.

The generated pipelines may then go to a training phase, in which a number of different optimizers may be used. An example of a corresponding cell in the python notebook is shown in FIG. 9. Once training is done, the accuracy of each generated pipeline may be obtained and shown that to the user (see for example FIG. 10). In this figure, nine pipelines are shown with accuracy varying from 0.51 to 0.8. These accuracy numbers may then be used to update the cost of associated actions. For example, the pipelines that include GaussianNB( ) may be seen to have a low accuracy, which may result in associating a high cost with the GaussianNB( ) action. FIG. 11 shows the nine generated pipelines sorted based on their cost. After one iteration, the “after feedback” column in this example takes into account the updated costs to re-sort. The pipelines that include GaussianNB( ) either drop down from the list or move down on the list illustrating the effect of the feedback. On the other hand, given that the pipeline that included QuadraticDiscriminantAnalysis( ) has a high accuracy of 0.8, the pipelines that include QuadraticDiscriminantAnalysis( ) may either move up the list or new pipelines with QuadraticDiscriminantAnalysis( ) are added to the list of generated pipelines.

### Computer Program Product

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### General

Any particular program nomenclature used in this description was merely for convenience, and thus the invention should not be limited to use solely in any specific application identified and/or implied by such nomenclature. Thus, for example, the routines executed to implement the embodiments of the invention, whether implemented as part of an operating system or a specific application, component, program, module, object, or sequence of instructions could have been referred to as a “program”, “application”, “server”, or other meaningful nomenclature. Indeed, other alternative hardware and/or software environments may be used without departing from the scope of the invention.

Therefore, it is desired that the embodiments described herein be considered in all respects as illustrative, not restrictive, and that reference be made to the appended claims for determining the scope of the invention.

What is claimed is:

1. A computer implemented method for automated generation of trained machine learning models, comprising:
receiving a space of possible automatically generated trained machine learning model pipelines, the space defined by a context-free grammar;
generating, by a processor, a planning model from the context-free grammar; and
automatically generating, by the processor, a plurality of candidate trained machine learning pipelines based upon the planning model.

2. The method of claim 1, further comprising receiving a selection from a user for a preferred machine learning pipeline from the plurality of candidate trained machine learning pipelines.

3. The method of claim 2, further comprising:
providing, by the processor, feedback from the selection of the preferred machine learning pipeline to an optimizer; and
updating, by the optimizer, the planning model based upon the feedback.

4. The method of claim 2, wherein generating the planning model comprises translating the context-free grammar to a hierarchical task network planning model.

5. The method of claim 4, wherein the hierarchical task network planning model comprises a solution to P_{G}=(Σ,V,O,M,s_{I},tn_{I}), where:
O={(n,∅,∅)|n∈Σ}
M={mᵣ=(α,∅,(Tᵣ, [symbol] ᵣ, τᵣ))|r=α→β∈R}, where β=e₁· . . . ·eₙ, Tᵣ={t₁, . . . ,tₙ}, tᵢ [symbol] ᵣtⱼ, if and only if i<j, and τᵣ(tᵢ)=eᵢ for 1≤i≤n,
s_{I}=∅, and
tn_{I}=({t_{I}}, ∅,τ_{I}), where τ_{I}(t_{I})=v₀.

6. The method of claim 4, further comprising:
translating the hierarchical task network planning model into a classical planning model; and
iteratively generating the plurality of candidate pipelines using the classical planning model.

7. The method of claim 6, further comprising training the plurality of candidate pipelines to generate the plurality of candidate trained machine learning pipelines.

8. The method of claim 7, further comprising:
generating feedback about the plurality of candidate trained machine learning pipelines; and
presenting the feedback to the user.

9. The method of claim 1, wherein the planning model comprises a strategy of action for training a machine learning model.

10. A computer program product for automated generation of trained machine learning models, the computer program product comprising a computer readable storage medium having program instructions embodied therewith, the program instructions executable by a processor to cause the processor to:
receive a space of possible automatically generated trained machine learning model pipelines, the space defined by a context-free grammar;
generate a planning model from the context-free grammar; and
automatically generate a plurality of candidate trained machine learning pipelines based upon the planning model.

11. The computer program product of claim 10, further comprising program instructions to receive a selection from a user for a preferred machine learning pipeline from the plurality of candidate trained machine learning pipelines.

12. The computer program product of claim 11, further comprising program instructions to:
provide feedback from the selection of the preferred machine learning pipeline to an optimizer; and
update the planning model based upon the feedback.

13. The computer program product of claim 11, wherein generating the planning model comprises translating the context-free grammar to a hierarchical task network planning model.

14. The computer program product of claim 13, further comprising program instructions to:
translate the hierarchical task network planning model into a classical planning model; and
iteratively generate a plurality of candidate pipelines using the classical planning model.

15. The computer program product of claim 14, further comprising program instructions to train the plurality of candidate pipelines to generate the plurality of candidate trained machine learning pipelines.

16. The computer program product of claim 15, further comprising program instructions to:
generate feedback about the plurality of candidate trained machine learning pipelines; and
present the feedback to the user.

17. A system for generating trained machine learning models, the system comprising a processor configured to execute instructions that, when executed on the processor, cause the processor to:
receive a space of possible automatically generated trained machine learning model pipelines, the space defined by a context-free grammar;
generate a planning model from the context-free grammar; and
automatically generate a plurality of candidate trained machine learning pipelines based upon the planning model.

18. The system of claim 17, further comprising instructions to receive a selection from a user for a preferred machine learning pipeline from the plurality of candidate trained machine learning pipelines.

19. The system of claim 18, further comprising instructions to:
provide feedback from the selection of the preferred machine learning model to an optimizer; and
update the planning model based upon the feedback.

20. The system of claim 18, wherein generating the planning model comprises translating the context-free grammar to a hierarchical task network planning model.

21. The system of claim 20, further comprising instructions to:
translate the hierarchical task network planning model into a classical planning model; and
iteratively generate a plurality of candidate pipelines using the classical planning model.

22. The system of claim 21, further comprising instructions to train the plurality of candidate pipelines to generate the plurality of candidate trained machine learning pipelines.

23. The system of claim 22, further comprising instructions to:
generate feedback about the plurality of candidate trained machine learning pipelines; and
present the feedback to the user.

24. A machine learning model created using the method of claim 1.

25. A computer implemented method for automated generation of trained machine learning models, comprising:
receiving a space of possible automatically generated trained machine learning models, the space defined by a context-free grammar;
generating, by a processor, a planning model from the context-free grammar, wherein the planning model comprises a strategy of action for training a machine learning model, and wherein generating comprises translating the context-free grammar to a hierarchical task network planning model, and wherein the hierarchical task network planning model comprises a solution to P^{G}=(Σ,V,O,M,s_{I},tn_{I}), where:
O={(n,∅,∅)|n∈Σ}
M={mᵣ=(α,∅,(Tᵣ, [symbol] ᵣ,τᵣ))|r=α→β∈R}, where β=e₁· . . . ·eₙ, Tᵣ={t₁, . . . ,tₙ}, tᵢ [symbol] ᵣtⱼ if and only if i<j, and τᵣ(tᵢ)=eᵢ for 1≤i≤n,
s_{I}=∅, and
tn_{I}=({t_{I}},∅,τ_{I}), where τ_{I}(t_{I})=v₀.
translating the hierarchical task network planning model into a classical planning model;
automatically generating, by the processor, a plurality of candidate trained machine learning pipelines based upon the classical planning model;
training a plurality of candidate pipelines to generate a plurality of trained pipelines;
generating feedback about the plurality of trained pipelines;
presenting the feedback to a user;
receiving a selection from a user for a preferred machine learning pipeline from the plurality of candidate trained machine learning pipelines;
providing, by the processor, feedback from the selection of the preferred machine learning pipeline to an optimizer; and
updating, by the optimizer, the planning model based upon the feedback.
